(19) United States
(12) Patent Application Publication
(10) Pub. No.: US 2013/0139818 A1
(43) Pub. Date: Jun. 6, 2013

(54) SPLIT FLOW FILTERING DEVICE

(71) Applicants: Britton G. Billingsley, St. Paul, MN (US); Pierre Legare, Brockville (CA)

(72) Inventors: Britton G. Billingsley, St. Paul, MN (US); Pierre Legare, Brockville (CA)

(73) Assignee: 3M Innovative Properties Company

(21) Appl. No.: 13/310,881

(22) Filed: Dec. 5, 2011

(51) Int. Cl. A62B 7/10; B01D 50/00; A42B 3/04; B01D 46/00

(52) U.S. Cl. 128/205.12; 55/484; 55/418; 96/55; 2/410

(57) ABSTRACT

A filtering device 10, 10′ that has a fluid inlet 12, a plenum 14, first and second filter layers 16 and 18, first and second fluid outlets 20 and 22, and a housing 24. The plenum 14 receives air that passes through the fluid inlet 12, and the first and second filter layers 16 and 18 are located on opposing sides of the plenum 14. The first and second fluid outlets 20 and 22 are located downstream to the first and second filter layers 16 and 18, respectively, on a side of each filter layer 16, 18 opposite the plenum 14. The housing 12 supports the first and second filter layers 16, 18 on opposing sides of the plenum 14. Very good distribution of fluid through the device 10 may be achieved because the plenum 14 and the filtering layers 16, 18 maintain their original relative positioning throughout use. Complex shapes can be produced, which enable the filtering device to accommodate devices of various configurations. Thicker filter media beds may be used on each side of the plenum to improve filtration performance and service life.

The present invention pertains to a filtering device where the airstream that enters the device at a fluid inlet is split at a plenum to pass into first and second filter layers and then out first and second fluid outlets. A housing enables the filter layers to maintain their positions on opposing sides of the plenum. The filtering device is particularly suitable for use in powered air purifying respirator systems.

### BACKGROUND

Respirators that filter air for breathing are frequently worn by individuals who work in areas where contaminated air is present. The respirators may operate under negative pressure, in which the wearer's lungs provide the power that draws air through the filter (see, for example, U.S. Patent RE35,062 to Brostrom et al.), or they may operate using positive pressure, in which a fan or other device supplies drives the ambient air through the filter (see, for example U.S. Pat. No. 7,748,381 to Croll et al). A powered air purifying respirator (PAPR) is often desired by users because of the comfort that they provide. Because the wearer does not have to supply the power needed to force the ambient air through the air filter, the wearer feels more comfort and may use the saved energy for other tasks.

PAPRs typically have (i) an electric motor and blower unit to force the air through the filter, (ii) a facepiece for delivering the clean air to the user, and (iii) a power source, such as a battery pack, to supply the energy needed to power the device. Known PAPRs have been assembled in a variety of configurations, but two common types that are available are belt pack PAPRs and helmet PAPRs. Belt pack PAPRs typically have the filtering unit worn about the user's waist, whereas helmet PAPRs have the filtering unit contained within the helmet. In both systems, an electrically-powered fan drives or draws the air through the filter cartridges, through the hose, and into the facepiece interior. Because the fan does the work required for air movement through the PAPR system, the user is able to comfortably receive a clean supply of air with little effort.

Each PAPR style has advantages and disadvantages. The belt pack style is easier for a user to wear because the filtering unit weight is carried on the wearer's waist and not the head. A two piece system, however, can be cumbersome because a connecting hose needs to be used, which can interfere with workplace demands. The helmet style PAPR avoids these drawbacks by being a single self-contained unit, but the filtering unit weight may become uncomfortable when worn for prolonged time periods.

Helmet-style PAPRs typically use a supported filter bag to filter air before it enters the interior gas space for breathing. The dust/mist filter bag holders sometimes have only limited or no support through the center of the dust/mist filter bag because the airflow alone is sufficient to keep the filter layers separated. A filter support used in some helmet-mounted respirators, however, is shown in FIG. 1. The filter bag holder 110 is designed to support a flat dust/mist filter bag in an arcuate form to fit within the crown of a helmet. The holder 110 is constructed of two members 112 and 114, with the smaller member 114 being held in compression to provide an opening 116 between the two members at one end thereof Both members 112 and 114 include a plurality of openings 118 and 120, respectively, that are aligned along the length of the holder 110. The filter bag holder 110 is designed primarily to maintain the filter bag in an arcuate shape. An example of a helmet-mounted PAPRs system is disclosed in U.S. Pat. No. 4,280,491 to Berg et al.

Another product that maintains the filtering bag in an arcuate shape is disclosed in U.S. Pat. No. 6,279,570 to Mittelstadt et al. As shown in FIG. 2, this filter support 200 has ribs 210 and 220 that are generally aligned with the longitudinal axis of the device. Some of the support ribs 210 are laterally offset from adjacent ribs 220. FIG. 3 shows how the filtration bag 310 may be placed around the support 200 in a helmet 300.

Another PAPR is described in International Publication WO 2011/126884 to Ausen. In this device the blower is placed within the helmet along with the filter media and a plenum that delivers ambient air to the filter. Air that exits the filter media then passes into another plenum where it is pulled into a blower assembly located centrally within the helmet. After passing through the blower assembly, the filtered air is then delivered to the wearer via a filtered air outlet and a filtered air passageway.

### SUMMARY OF THE INVENTION

The present invention provides a new filtering device that comprises a fluid inlet, a plenum, first and second filter layers, first and second fluid outlets, and a housing. The plenum receives air that passes through the fluid inlet, and the first and second filter layers are located on opposing sides of the plenum. The first and second fluid outlets are located downstream to the first and second filter layers, respectively, on a side of the filter layer opposite the plenum. The housing supports the first and second filter layers on opposing sides of the plenum.

The present invention is beneficial over known filtering devices in that it can provide very good distribution of fluid through the device because the plenum and the filtering layers maintain their original relative positioning throughout use. The housing keeps the filtering layers in their intended positions without the use of an internal arcuate support, like the articles shown in FIGS. 1-3 discussed above, and the housing also allows complex shapes to be produced, which shapes enable the filtering device to accommodate helmets of various configurations. The use of a housing in the present filtering device also enables a thicker bed of filter media to be used on each side of the plenum. The ability to use more filter media can improve filtration performance and service life of the device. Further, a good heretic seal can be achieved at the sidewall of the inventive filtering device while consuming little space widthwise. Conventional products have had the first and second layers of filter media sewn together at the edges. This method of joining the filtering layers causes the product to project laterally at the edges to complete the construction. Known assemblies thus need additional lateral space to accommodate the filtering device. These benefits make the filtering device of the present invention particularly beneficial and suitable for use in the interior of a helmet or hood of a PAPR.

### GLOSSARY

In reference to the invention, the following terms will have the definitions that follow:

“air flow” means greater than insignificant or immeasurable air movement;

“clean air” means a volume of ambient air that has been filtered to remove contaminants;

“contaminants” mean particles (including dusts, mists, and fumes) and/or other substances that generally may not be considered to be particles (e.g., organic vapors, et cetera) but which may be suspended in the ambient air;

“crown space” means the space between a wearer's head and the interior side of a helmet;

“downstream” means located at point in time in an air stream later than the reference point to which it refers;

“exhaled air” means air that is exhaled by a person;

“filtering device” means a device that is designed to remove contaminants from air;

“filter media” or “filter material” mean an air permeable material that is designed to remove contaminants from air that passes through it;

“fluid inlet” means an area, surface, or volume of space through which air can enter;

“filter layer” means an air-permeable structure that includes one or more layers and that is designed to remove contaminants from air that passes through it;

“fluid outlet” means an area or portion through which air can exit;

“helmet” means an apparatus that is adapted to be worn on the head of a person for purposes of protecting the head from impact;

“housing” means a structure or combination of parts that is fashioned for housing or containing another item wholly or partially;

“interior gas space” means the space in front of a person's face where clean air can be inhaled;

“longitudinal dimension” means extending generally along the length of the filtering device;

“outlet” means an area, surface, or volume of space through which air can exit;

“powered air purifying respirator” or “PAPR” means a device that is capable of supplying clean filtered air to a wearer where the air is filtered on the wearer through use of energy from a source other than the wearer;

“plenum” means a volume of space where air flow can be distributed in more than one direction;

“transverse axis” means a dimension that extends generally perpendicular to the longitudinal dimension.

### BRIEF DESCRIPTION OF THE DRAWINGS

FIG. 1 is a perspective view of a first prior art support 100 for supporting a filtering device used in the helmet of a PAPR.

FIG. 2 is a perspective view of a second prior art support 200 for supporting a filtering bag that may be used in a helmet of a PAPR.

FIG. 3 is a side view of the prior art filtering device 200 placed within the confines of a helmet 300.

FIG. 4 is a side schematic view of the filtering device 10 in accordance with the present invention.

FIG. 5 is a top schematic view of the filtering device 10 in accordance with the present invention.

FIG. 6 is side cross-sectional view of a PAPR 43 in accordance with the present invention.

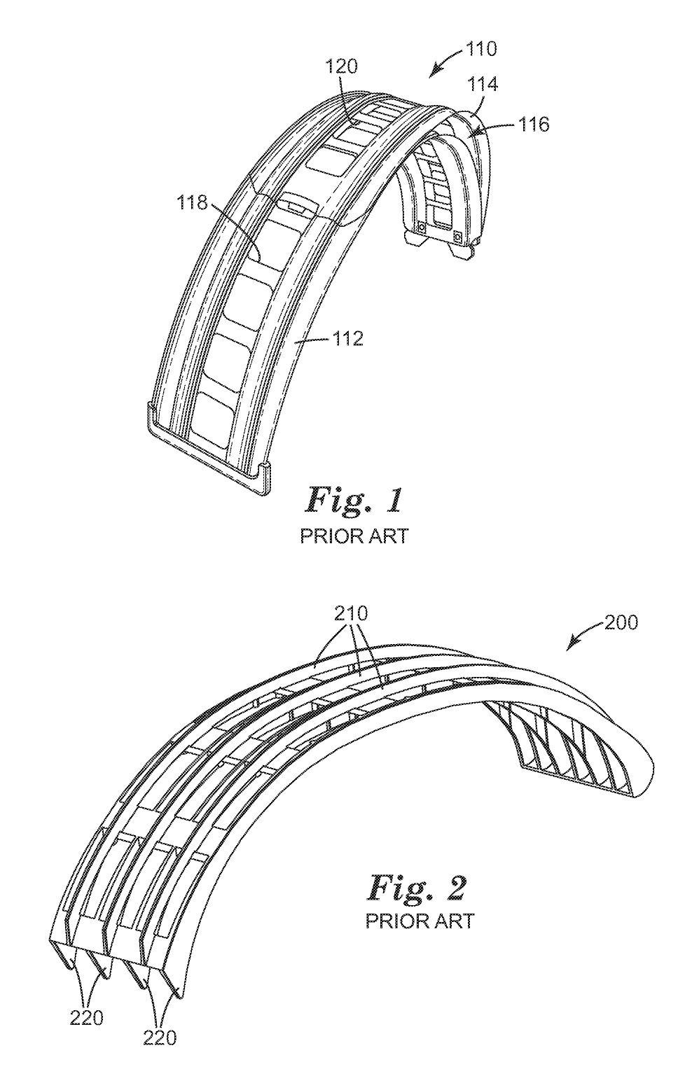

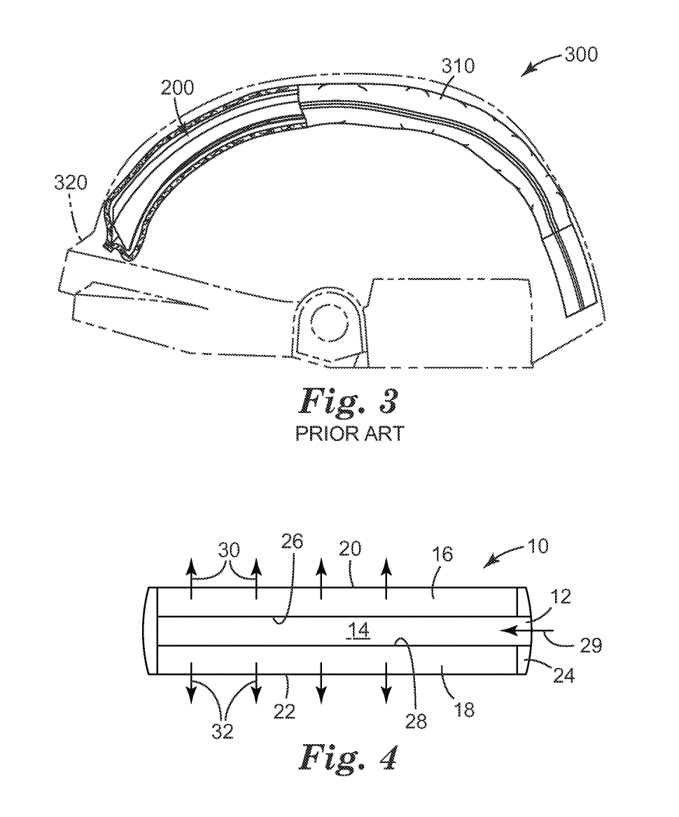

### DETAILED DESCRIPTION

In practicing the present invention, a filtering device is provided which can be used in the helmet of a powered air purifying respirator (PAPR). The device employs a housing, which may be in the form of a sidewall, that keeps first and second layers of filter media in a spaced apart relationship on opposing sides of a plenum. The use of a housing eliminates the need for an interior support structure placed within the interior of a bag-like filter media. The housing may be fashioned into essentially any desired shape intended for use, for example, within personal protection respiratory equipment. Such a shape may include an arcuate configuration in its longitudinal dimension or a more complicated shape that is curved in the traverse axis as well.

FIG. 4 shows the inventive filtering device 10, which has a fluid inlet 12, a plenum 14, first and second filter layers 16 and 18, first and second fluid outlets 20 and 22, and a housing 24. The plenum 14 receives air that passes through the fluid inlet 12, and the first and second filter layers 16 and 18 are located on opposing sides 26 and 28 of the plenum 14. The first and second fluid outlets 20 and 22 are located downstream to the first and second filter layers 16 and 18, respectively, on a side of the filter layer 16 or 18 opposite the plenum 14. The housing 24 supports the first and second filter layers 16 and 18 on opposing sides 26 and 28 of the plenum 14. In use, ambient air that may contain contaminants enters the device at the inlet 12 where it then passes into the plenum 14. At the plenum 14, the airstream 29 is split into two streams 30 and 32. The first portion 30 of the split airstream 29 passes through the first layer 16 of filter media, and the second portion 32 of the original airstream 29 passes through the second layer 18 of filter media. The filtered air then exits the device 10 at the first and second outlets 20 and 22, respectively. The filtered air that exits the device may be made available for a person to breath. Such clean air availability may be provided to, for example, a clean room, a tent, a vehicle such as an automobile or airplane, an article of protective clothing, and a PAPR as described below.

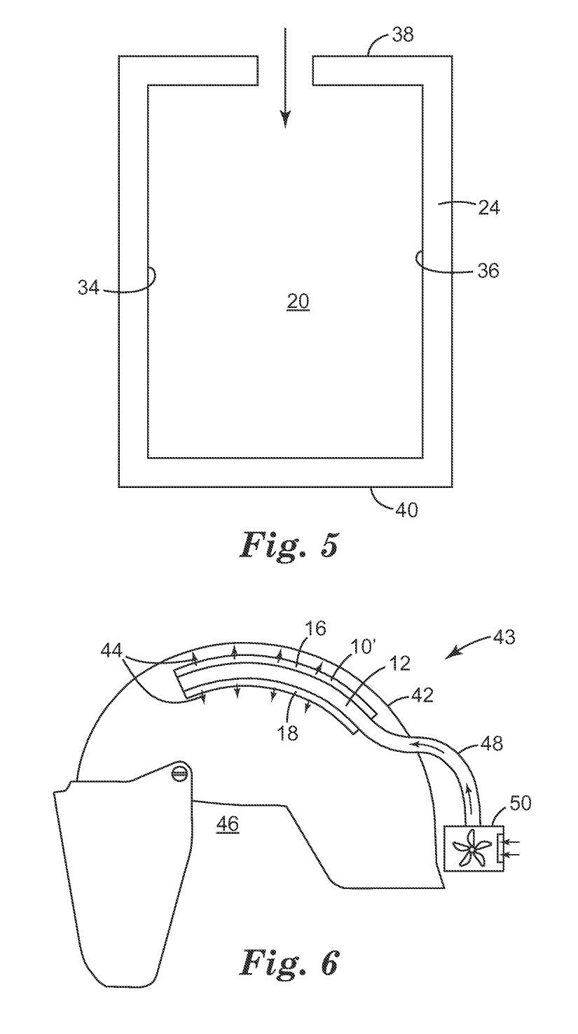

FIG. 5 shows that the first and second filter layers may extend across the device 10 widthwise from a first side 34 of the device to the second side 36. The housing sidewall 24 precludes unfiltered air from bypassing the filter layer 20. The filter layer 20 may be hermetically adhered to the sidewall using a suitable adhesive or other means to preclude such bypass. See, for example, U.S. Pat. No. 5,512,172 to Marble for an example of how a filter layer may be secured to a housing. The sidewall also provides very good support for each of the filter layers in the device, thereby enabling thicker or loftier filter layers to be used in the filtering device which may increase product service life.

FIGS. 4 and 5 show the filtering device being in the form of a planar rectangular shape. The filtering device, however, may come in a variety of shapes. The device may be fashioned such that the plenum 14 and the filtering layers follow a curved path extending from a third side 38 to a forth side 40 of the housing 24. The device also may be curved, extending from the first side 34 to the second side 36.

The filtering device also may be curved around a third axis from top to bottom, or in all three dimensions. A curved filtering device of the invention is beneficial in that the device may be fashioned into a various shapes, which can enable the device into which it is used to be configured into more adaptable or suitable shapes for users etc.

FIG. 6 shows an example of a curved filtering device 10′ in accordance with the present invention being used in the crown space of a helmet 42 of a PAPR 43. Clean air 44 that exits the PAPR 43 enters the interior gas space 46 of the helmet where it can he inhaled by the wearer. Atmospheric air is supplied to the fluid inlet 12 of the device 10′ via a conduit 48. A blower 50 drives or forces the unfiltered air through the conduit 48 into the inventive split flow filtering device 10′. The blower can be operatively powered by a battery that exhibits passivation—see U.S. Pat. No. 7,947,109 to Sayers et al. The blower can be positioned to be isolated from the exterior environment—see U.S. Pat. No. 6,796,304 to Odell et al.; see also U.S. Pat. No. 6,823,867 to Avery et al. The air flow also can be calibrated in the respirator system—see U.S. Pat. No. 6,666,209 to Bennett et al. and managed otherwise—see U.S. Pat. No. 7,197,774 to Curran et al. A flow indicator may be used to alert the wearer if air flow falls below a predetermined value. Because air passes through two filter layers, namely, first and second filter layers 16 and 18, more surface area is available for filtering, thereby lowering the pressure drop across the device 10′. Lower pressure drop means that less energy is needed to drive the ambient air through the filter media. Further the additional surface area may extend the service life of the media since it may take longer for the pores in the media to become plugged with various contaminants. The helmet could be, for example, a welding helmet—see, for example, U.S. Pat. Nos. 6,934,967 to Miyashita et al. and 7,637,622 to Magnusson et al.—with a head suspension system (U.S. Pat. No. 6,367,085 to Berg. The invention also could be used in a hooded device—see U.S. Pat. No. 7,104,264 to Lee et al.

The plenum of the present invention may be an open space defined by the shape and configuration of the housing and the first and second layers of filter media. The plenum also may include physical structure that assists in providing structure to the overall device and/or that assists in splitting fluid flow into two or more flow streams towards two or more independently operating filter media layers or sections. An example of a plenum that may be used in the filtering device of the present invention is disclosed in U.S. Patent Application 2007/0144123 to Angadjivand et al. The plenum also could be configured to include spacer elements and/or channels between the filtering layers.

The housing may be fashioned from a variety of materials into a variety of shapes. Examples of materials from which the housing may be made include plastics, metals, pressed or bonded fibrous composite structures. Depending on the materials used and the desired structure of the resulting device, the housing may be made by various techniques, including injection molding, vacuum forming, die cutting, rapid prototyping, three dimensional computer aided manufacturing, stamping, die extrusion, and casting. The housing also could be a roll-based product—see for example, U.S. patent application Ser. No. 12/784,182 to Billingsley et al. The use of a housing is beneficial over known products in that there is no need for an internal structural member to keep the first and second filter layers properly separated and extended. The housing defines the location of the filter layers relative to one another and to the overall structure.

The filter media that is used in connection with the present invention may include one or more layers of particulate and/or gaseous filter media. Particulate filter media is fashioned to remove particulates that are suspended in the ambient air, and the gaseous media is fashioned to remove vapors that are suspended therein. The filtration layers may come in a variety of shapes and forms and for respirator use may have a thickness of about 0.2 millimeters (mm) to 2 centimeter (cm), or 0.5 to 16 mm, and it could be a generally planar filter or it could be corrugated to provide an expanded surface area—see, for example, U.S. Pat. Nos. 5,804,295 and 5,656,368 to Braun et al. Each filtration layer also may include multiple filtration layers joined together by an adhesive or any other means. The filter layers also may include parallel channels as described, for example, in U.S. Pat. Nos. to 6,752,889 and 6,280,824 to Insley et al. Essentially any suitable material that is known (or later developed) for forming a filtering layer may be used for the filtering material. Webs of melt-blown fibers, such as those taught in Wente, Van A., Superfine Thermoplastic Fibers, 48 Indus. Engn. Chem., 1342 et seq. (1956), especially when in a persistent electrically charged (electret) form are especially useful (see, for example, U.S. Pat. No. 4,215,682 to Kubik et al.). These melt-blown fibers may be microfibers that have an effective fiber diameter less than about 20 micrometers (μm) (referred to as BMF for “blown microfiber”). Effective fiber diameter may be determined according to Davies, C. N., The Separation Of Airborne Dust Particles, Institution Of Mechanical Engineers, London, Proceedings 1B, 1952. BMF webs that contain fibers formed from polypropylene, poly(4-methyl-1-pentene), and combinations thereof are commonly used. Electrically charged fibrillated-film fibers as taught in van Turnhout, U.S. Patent Re. 31,285, also may be suitable, as well as rosin-wool fibrous webs and webs of glass fibers or solution-blown, or electrostatically sprayed fibers, especially in microfilm form. Electric charge can be imparted to the fibers by contacting the fibers with water as disclosed in U.S. Pat. Nos. 6,824,718 to Eitzman et al., 6,783,574 to Angadjivand et al., 6,743,464 to Insley et al., 6,454,986 and 6,406,657 to Eitzman et al., and 6,375,886 and 5,496,507 to Angadjivand et al. Electric charge also may be imparted to the fibers by corona charging as disclosed in U.S. Pat. No. 4,588,537 to Klasse et al. or by tribocharging as disclosed in U.S. Pat. No. 4,798,850 to Brown. Also, additives can be included in the fibers to enhance the filtration performance of webs produced through the hydro-charging process (see U.S. Pat. No. 5,908,598 to Rousseau et al.). Fluorine atoms, in particular, can be disposed at the surface of the fibers in the filter layer to improve filtration performance in an oily mist environment—see U.S. Pat. Nos. 6,398,847 B1, 6,397,458 B1, and 6,409,806 B1 to Jones et al. Typical basis weights for electret BMF filtration layers are about 10 to 100 grams per square meter. Packed beds of active-particulate also may be used as well as permeable shaped structures of active-particulate which are held together with, for example, PSA microparticulate—see U.S. Pat. No. 6,391,429 to Senkus et al.—or bonded sorbent particulate as described in U.S. Pat. No. 5,033,465 to Braun et al. An example of a fibrous matrix that contains active particulate is shown in U.S. Patent Application No. 2005/0169820A1. The sorbent particles may be enmeshed in the web, typically, such that there is at least about 60 weight percent sorbent particles enmeshed in the web. The fibers used in the particle-containing web typically have sufficiently greater crystallization shrinkage than similar fibers. The fibers typically comprise polypropylene, and the sorbent particles are typically evenly distributed in the web so that the web has an Adsorption Factor A of at least 1.6×10⁴/millimeters (mm) water. The porous sheet articles typically exhibit a low pressure drop, have a long service life, and have an Adsorption Factor A exceeding that of packed-bed carbon. The Adsorption Factor A can be calculated using parameters or measurements similar to those described in Wood, JOURNAL OF THE AMERICAN INDUSTRIAL HYGIENE ASSOCIATION, 55(1):11-15 (1994). Further information regarding Adsorption Factor A may be found in either of the patent applications cited above in this paragraph. The active-particulate that may be used in the filters of the present invention include particles or granules that are suited to perform some action or function attributable to some characteristic or property, including chemical change properties such as reaction, catalysis, and ion exchange, and/or physical properties such as high surface area, porosity, and relatively small size and shape. One example of active-particulate is particles that interact with components in a fluid to remove or alter their composition. The components in the fluid may be sorbed onto or into the active-particulate, or they may be reacted to make their composition more benign. The active-particulate accordingly may be sorptive, catalytic, or reactive. Examples of active-particulate materials that may be used in connection with the present invention include sorbent microparticulate granules, such as active carbon, chemically surface-treated activated carbon, alumina, silica gel, bentonite, kaolin diatomaceous earth, powdered zeolites (both natural and synthetic), ion exchange resins and molecular sieves, and particulates such as catalytic particles and particles containing encapsulated compounds. Commonplace active-particulates include activated carbon, chemically-treated carbon, and alumina particulate. Examples of commercially available activated carbon that may be used in the present invention include Kuraray 12×20 type GG (available from Kuraray Chemical Corporation, Osaka, Japan and Calgon 12×30 URC available from Calgon Carbon Corporation, Pittsburgh, Pa. Patents that describe various types of active-particulate that may be used in the present invention include U.S. Patents 7,309,513 to Brey et al., 7,004,990 and 6,391,429 to Senkus et al., 6,767,860 to Hem et al., 5,763,078 to Braun et al., and 5,496,785 to Abler.

Although the invention has been illustrated for use in conjunction with personal respiratory protection devices like welding helmets and PAPRs, the invention also could be used with collective protection system or installations like buildings and tents. In such instances a plurality of split flow filters—or stacks of such devices—could be used to filter air before it enters the building or installation; see, for example, U.S. Pat. No. 7,995,570 to Insley et al.

This invention may take on various modifications and alterations without departing from its spirit and scope. Accordingly, this invention is not limited to the above-described but is to be controlled by the limitations set forth in the following claims and any equivalents thereof.

This invention also may be suitably practiced in the absence of any element not specifically disclosed herein.

All patents and patent applications cited above, including those in the Background section, are incorporated by reference into this document in total. To the extent there is a conflict or discrepancy between the disclosure in such incorporated document and the above specification, the above specification will control.

1. A filtering device that comprises:
(a) a fluid inlet;
(b) a plenum that receives air that passes through the fluid inlet;
(c) first and second filter layers located on opposing sides of the plenum;
(d) first and second fluid outlets located downstream to the first and second filter layers, respectively, on a side of each filter layer opposite the plenum; and
(e) a housing that supports the first and second filter layers on opposing sides of the plenum.

2. The filtering device of claim 1, wherein the plenum and the first and second filter layers maintain their original relative positioning throughout use.

3. The filtering device of claim 2, wherein the housing assists in keeping the filtering layers in their intended positions.

4. The filtering device of claim 3, wherein the wherein the housing keeps the first and second filter layers in their intended positions without use of an internal support.

5. The filtering device of claim 1, wherein the first and second filter layers each have a thickness of 0.2 millimeters to 1 centimeter.

6. The filtering device of claim 5, wherein the first and second filter layers each have a thickness of 0.5 to 16 mm.

7. The filtering device of claim 6, wherein a hermetic seal is provided where the first and second filter layers meet a sidewall of the housing.

8. The filtering device of claim 7, having an arcuate configuration in its longitudinal dimension.

9. The filtering device of claim 8, having a curvature in along a transverse axis.

10. The filtering device of claim 1, wherein an airstream that enters the device at the fluid inlet is split into two streams, a first portion of the split airstream passes through the first filter layer, and the second portion of the split airstream passes through the second filter layer.

11. The filtering device of claim 10, wherein the plenum and the first and second filter layers exhibit a curvature along the longitudinal dimension from a first side to a second side.

12. The filtering device of claim 11, wherein the plenum and filter layers also are curved transversely around a second axis from a third side to a forth side of the housing and are curved around a third axis.

13. The filtering device of claim 1, wherein the plenum is an open space defined by the housing and the first and second filter layers.

14. The filtering device of claim 1, wherein the plenum includes physical structure that assists in providing structure to the overall device.

15. The filtering device of claim 14, wherein the plenum assists in splitting fluid flow into two or more flow streams towards at least the first and second filters.

16. The filtering device of claim 1, wherein the housing has no internal structural member to keep the first and second filter layers separated and extended.

17. The filtering device of claim 1, wherein the first and second filter layers each comprise a particulate filter layer and a gaseous filter layer.

18. The filtering device of claim 1, wherein the particulate filter layer contains electrically charged microfibers, and the gaseous filter layer contains activated carbon.

19. A helmet that contains the filtering device of claim 8.

20. A powered air purifying respirator that contains the filtering device of claim 11.
